(19) United States
(12) Patent Application Publication
(10) Pub. No.: US 2016/0077771 A1
(43) Pub. Date: Mar. 17, 2016

(54) INFORMATION PROCESSING DEVICE, INFORMATION PROCESSING SYSTEM, AND COMPUTER-READABLE RECORDING MEDIUM

(71) Applicant: Nobuya MONDEN, Kanagawa (JP)

(72) Inventor: Nobuya MONDEN, Kanagawa (JP)

(73) Assignee: RICOH COMPANY, LIMITED, Tokyo (JP)

(21) Appl. No.: 14/849,690

(22) Filed: Sep. 10, 2015

(30) Foreign Application Priority Data
Sep. 17, 2014 (JP) 2014-188787

(51) Int. Cl. G06F 3/12; H04N 1/00

(52) U.S. Cl. CPC G06F 3/1207; H04N 1/00204; H04N 1/00493; H04N 1/00408; H04N 1/00079; G06F 3/121; G06F 3/1234; H04N 2201/0094

(57) ABSTRACT

An information processing device comprises: a screen data generating unit that generates, in a plurality of formats, screen data to be transmitted to an external device to cause the external device to display a screen; a notification unit that notifies the external device of the formats of the screen data generated by the screen data generating unit; and a screen data transmission unit that transmits, in accordance with specification of a format, out of the formats, that is transmitted from the external device in response to notification of the formats by the notification unit, the screen data generated by the screen data generating unit in the specified format to the external device.

### CROSS-REFERENCE TO RELATED APPLICATIONS

The present application claims priority to and incorporates by reference the entire contents of Japanese Patent Application No. 2014-188787 filed in Japan on Sep. 17, 2014.

### BACKGROUND OF THE INVENTION

1. Field of the Invention

The present invention relates to an information processing device, an information processing system, and a computer-readable recording medium.

2. Description of the Related Art

When a conventional image processing device needs to inform a user of a message, the image processing device dynamically creates screen data for a screen that displays the message, and transmits the screen data to an external device operated by the user to cause the external device to display such screen data.

For example, a conventional technology in Japanese Patent Application Laid-open No. 2007-206999 allows an image processing device to automatically generate a help page as a web page in response to a request from a client terminal, and transmit the web page to the client terminal, whereby the client terminal can operate the image processing device through the web page.

In the technology described in Japanese Patent Application Laid-open No. 2007-206999, however, display capability of the screen of the client terminal is not taken into consideration in generating the web page by the image processing device.

This configuration may cause problems in some cases. For example, when the client terminal has a small display, the web page is reduced to the size of the display and is displayed illegibly, or when the client terminal has a large display, it displays the web page with too much blank space left on the display. When, for example, the image processing device generates a web page containing animation, but the client terminal does not have animation display capability, necessary information cannot be delivered to the user.

The same kinds of problems may also occur when any desired information processing device other than the image processing device generates data for a screen to be displayed on an external display device.

In view of the conventional problems, there is a need to provide an information processing device that dynamically generates screen data and enables an external display device to display a screen, based on the generated screen data, that can properly transfer necessary information to the user when the display capability of the external display device varies.

### SUMMARY OF THE INVENTION

It is an object of the present invention to at least partially solve the problems in the conventional technology.

According to the present invention, there is provided an information processing device comprising: a screen data generating unit that generates, in a plurality of formats, screen data to be transmitted to an external device to cause the external device to display a screen; a notification unit that notifies the external device of the formats of the screen data generated by the screen data generating unit; and a screen data transmission unit that transmits, in accordance with specification of a format, out of the formats, that is transmitted from the external device in response to notification of the formats by the notification unit, the screen data generated by the screen data generating unit in the specified format to the external device.

The present invention also provides an information processing system comprising: an information processing device; and a display device that is external to the information processing device and includes a display unit. In the information processing system; the information processing device comprises a screen data generating unit that generates, in a plurality of formats, screen data to be transmitted to the display device to cause the display device to display a screen, a notification unit that notifies the display device of the formats of the screen data generated by the screen data generating unit, and a screen data transmission unit that transmits, in accordance with specification of a format, out of the formats, that is transmitted from the display device in response to notification of the formats by the notification unit, the screen data generated by the screen data generating unit in the specified format to the display device; and the display device comprises a specifying and notification unit that specifies, when the display device is notified by the information processing device of the formats, a format out of the notified formats based on display capability of the display unit included in the display device, and notifies the information processing device of the specified format, and a display controlling unit that causes the display unit to display the screen based on the screen data transmitted from the information processing device.

The present invention also provides a non-transitory computer-readable recording medium that contains a computer program that causes a computer to function as: a screen data generating unit that generates, in a plurality of formats, screen data to be transmitted to an external device to cause the external device to display a screen; a notification unit that notifies the external device of the formats of the screen data generated by the screen data generating unit; and a screen data transmission unit that transmits, in accordance with specification of a format, out of the formats, that is transmitted from the external device in response to notification of the formats by the notification unit, the screen data generated by the screen data generating unit in the specified format to the external device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a configuration of an image forming system that is an information processing system according to a first embodiment of the present invention;

FIG. 2 is a diagram illustrating a hardware configuration of a multifunction peripheral (MFP) illustrated in FIG. 1;

FIG. 3 is a diagram illustrating a hardware configuration of a terminal device illustrated in FIG. 1;

FIG. 4 is a diagram illustrating a functional configuration of the MFP and the terminal device illustrated in FIG. 1;

FIG. 5 is a diagram illustrating an example of formats of screen data generated by an error screen data generating module;

FIG. 6 is a diagram illustrating an example of an error notification screen;

FIG. 7 is a sequence diagram illustrating operations of the MFP and the terminal device performed when the MFP illustrated in FIG. 1 causes the terminal device to display an error notification screen for notifying a user of an error that is occurring during execution of a job;

FIG. 8 is a diagram, corresponding to FIG. 4, illustrating a functional configuration of an MFP and a terminal device according to a second embodiment of the present invention;

FIG. 9 is a sequence diagram, corresponding to FIG. 7, illustrating operations of the MFP and the terminal device according to the second embodiment;

FIG. 10 is a sequence diagram, corresponding to FIGS. 7 and 9, illustrating operations of an MFP and a terminal device according to a third embodiment of the present invention;

FIG. 11 is a functional block diagram, corresponding to FIG. 4, illustrating functions of an MFP and a terminal device according to a fourth embodiment of the present invention; and

FIG. 12 is a functional block diagram, corresponding to FIG. 4, illustrating functions of an MFP and a terminal device according to a fifth embodiment of the present invention.

### DETAILED DESCRIPTION OF THE PREFERRED EMBODIMENTS

The following describes embodiments of the present invention with reference to the accompanying drawings.

### First Embodiment

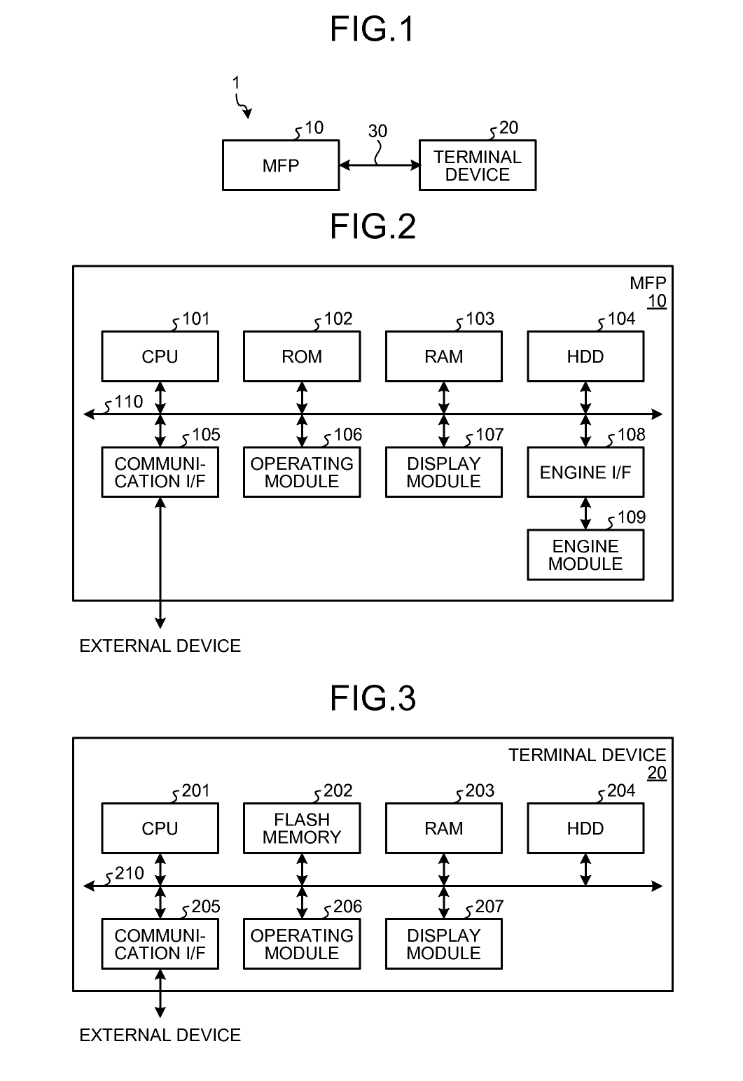

### FIGS. 1 to 6

FIG. 1 illustrates a configuration of an image forming system that is an information processing system according to a first embodiment of the present invention.

This image forming system 1 illustrated in FIG. 1 includes an MFP (digital multifunction peripheral) 10 that is an information processing device according to the first embodiment of the present invention, and a terminal device 20 that is an external device to the MFP 10. The MFP 10 and the terminal device 20 are communicably connected with each other via a communication channel 30. The correspondence between the MFP 10 and the terminal device 20 is not necessarily one-to-one, but may be changed depending on the cases.

The MFP 10 is an image forming device having various functions such as copying, printing, scanning, facsimile communication, and storing documents.

The terminal device 20 is a display device including a display unit for displaying a screen to a user. The terminal device 20 functions, by executing a required application program, as a controller that receives operations on the MFP 10 through the screen. The terminal device 20 may be, as hardware, a portable device such as a smartphone or a tablet, or a stationary device such as a desktop personal computer (PC).

The communication channel 30 may be a wired or wireless channel, or may be implemented by any form of communication. The communication may be network communication or peer-to-peer communication. The communication channel 30 may employ a means of communication of, for example, universal serial bus (USB), serial connection, a local area network (LAN), or a wide area network (WAN).

FIG. 2 illustrates a hardware configuration of the MFP 10 illustrated in FIG. 1.

As illustrated in FIG. 2, the MFP 10 includes a central processing unit (CPU) 101, a read only memory (ROM) 102, a random access memory (RAM) 103, a hard disk drive (HDD) 104, a communication interface (I/F) 105, an operating module 106, a display module 107, and an engine I/F 108. These modules are connected with each other via a system bus 110. The engine I/F 108 is connected to an engine module 109.

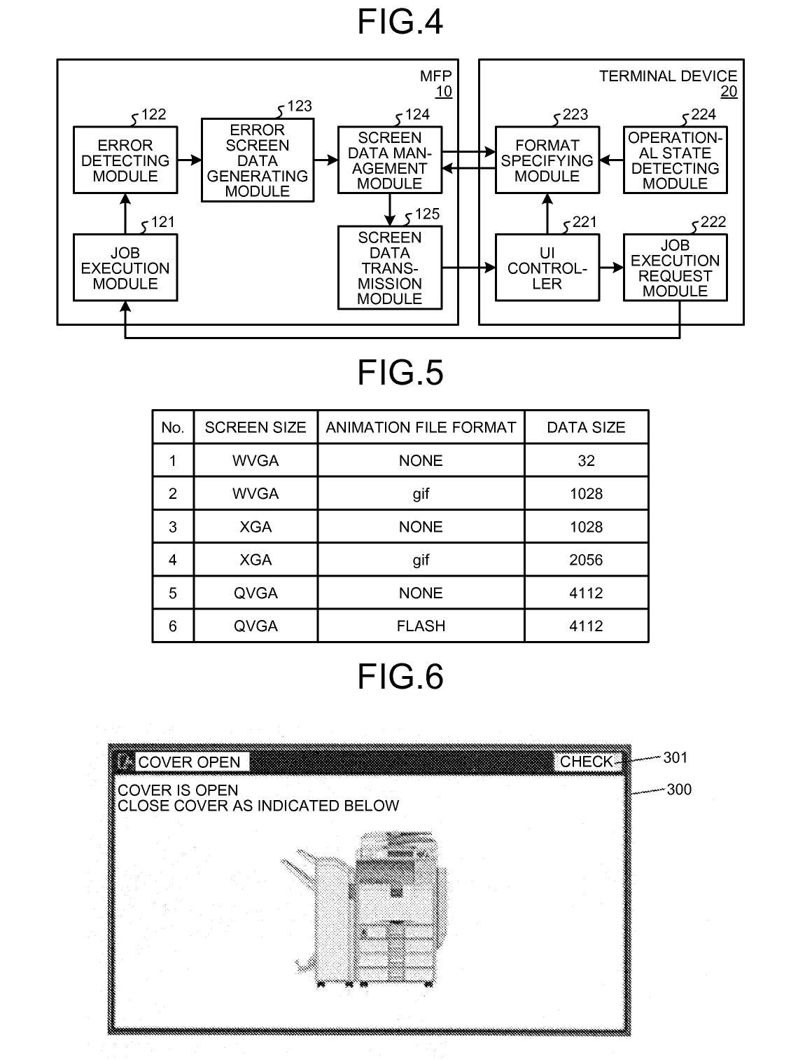

The CPU 101 executes a computer program stored in the ROM 102 or the HDD 104 on the RAM 103 as a work area. With this operation, the CPU 101 controls the entire MFP 10 and implements various functions including functions to be described later with reference to FIG. 4.

The ROM 102 and the HDD 104 are non-volatile storage media (storage units) that store therein various computer programs to be executed by the CPU 101 and various kinds of data to be described later.

The communication I/F 105 is an interface for communicating with other devices such as the terminal device 20 via the communication channel 30. The communication I/F 105 may be any type of interfaces that comply with the standards of the communication channel 30 used in the system.

The operating module 106 is an operating unit for receiving operations from the user. The operating module 106 includes various kinds of buttons and switches and a touch panel, and can receive operations on graphical user interfaces (GUIs) displayed on the display module 107.

The display module 107 is an exhibiting unit for exhibiting, in addition to the GUIs, the operational state and contents of the setting of the MFP 10, and messages to the user. The display module 107 includes, for example, a liquid crystal display and a lamp.

When the MFP 10 does not need to directly receive the operations from the user, such as in a case where the terminal device 20 can control all the functions of the MFP 10, the MFP 10 may eliminate the operating module 106 and the display module 107.

The engine I/F 108 is an interface that connects the engine module 109 to the system bus 110 to make the engine module 109 controllable by the CPU 101. The engine module 109 implements functions that operate with mechanical movements, such as an image forming unit for forming an image on paper on the basis of image data and an image reading unit for reading an image on a document to output image data indicating the contents of the image.

FIG. 3 illustrates a hardware configuration of the terminal device 20 illustrated in FIG. 1.

As illustrated in FIG. 3, the terminal device 20 includes a CPU 201, a flash memory 202, a RAM 203, a hard disk drive (HDD) 204, a communication I/F 205, an operating module 206, and a display module 207. These modules are connected with each other via a system bus 210.

The CPU 201 executes a computer program stored in the flash memory 202 on the RAM 203 that is a work area. With this operation, the CPU 201 controls the entire terminal device 20 and implements various functions including functions to be described later with reference to FIG. 4.

The flash memory 202 is a non-volatile storage medium (storage unit) that stores therein various computer programs to be executed by the CPU 201 and various kinds of data to be described later.

The communication I/F 205 is an interface for communicating with other devices such as the MFP 10 via the communication channel 30. The communication I/F 205 may be any type of interfaces that comply with the standards of the communication channel 30 used in the system.

The operating module 206 is an operating unit for receiving operations from the user. The operating module 206 includes various kinds of buttons and switches and a touch panel, and can receive operations on GUIs displayed on the display module 207.

The display module 207 is a display unit for displaying various types of screens including the GUIs, and may be configured by, for example, a liquid crystal display. Some GUIs may be generated by a function of an application program executed by the CPU 201, and others may be displayed on the basis of screen data received from the MFP 10.

FIG. 4 illustrates a configuration of functions, out of the functions included in the MFP 10 and the terminal device 20, relating to operations for causing the terminal device 20 to display an error notification screen on the basis of screen data generated by the MFP 10. Although described here, as an example, is the error notification screen displayed on the terminal device 20, the terminal device 20 can also display other screens in the same manner, which only differ from the error notification screen in the contents displayed on the screens and events that trigger the display of the screens. The functions illustrated in FIG. 4 are implemented by the CPU 101 of the MFP 10 or the CPU 201 of the terminal device 20 by controlling operations of appropriate hardware.

As illustrated in FIG. 4, the MFP 10 includes a job execution module 121, an error detecting module 122, an error screen data generating module 123, a screen data management module 124, and a screen data transmission module 125.

The job execution module 121 has a function of executing operations relating to various jobs such as image forming, image reading, and image transmission in accordance with an instruction received at the operating module 106 or a request received from an external device such as the terminal device 20.

The error detecting module 122 has a function of detecting an error that is determined when a failure occurs during a job executed by the job execution module 121 and the job is no longer executable. Examples of the failure include paper jam and shortage of paper and toner. The error detecting module 122 may detect errors that are determined when other failures occur in the MFP 10 during operations other than the execution of a job.

The error screen data generating module 123 has a function of generating, when the error detecting module 122 detects an error, screen data for an error notification screen corresponding to the error. The error notification screen is generated to notify the user of the terminal device 20 of the error that has occurred in the MFP 10.

The error screen data generating module 123 generates the screen data in a plurality of formats that are different from each other in screen size and form of the display contents on the assumption that the terminal device 20 that displays the error screen may have a different display size and display processing capability depending on the type of the terminal device 20.

FIG. 5 illustrates an example of formats.

The example of FIG. 5 includes three types of screen sizes for a liquid crystal display used for displaying the screen data: wide video graphics array (WVGA); extended graphics array (XGA); and quad VGA (QVGA). The example of FIG. 5 includes three types of animation file formats for the screen: no animations (NONE); gif format (gif); and Flash format (FLASH). Data size is a size of screen data determined by the screen sizes and the animation file formats.

“No.” denotes numbers for identifying the formats.

When the error screen data generating module 123 generates screen data, it changes the size of fonts, images, and animations depending on the screen sizes. The error screen data generating module 123 also determines which of image formats is to be taken between a static image and a moving image for notifying a user of information that needs to be delivered to the user in the form of an image, and determines how the moving image is moved, depending on the animation file formats. The error screen data generating module 123 may store in advance, in a certain memory, display data of components, in a plurality of formats, to be used in generating a screen corresponding to a certain error, and generate the screen data by combining the display data. The display data of the components may be acquired from an external server.

FIG. 6 illustrates an example of the error notification screen displayed on the basis of the screen data generated by the error screen data generating module 123.

An error notification screen 300 illustrated in FIG. 6 corresponds to the format of No. 1 in FIG. 5. The error notification screen 300 notifies the user of the detail of an error (cover open) by letters and displays how the user can solve the error (close the cover) by letters and a static image. The user can understand what kind of error is occurring and how the error can be solved by referring to the screen. The error notification screen 300 includes a check button 301. When the user operates the button, the error notification screen 300 is closed. The program code for this operation is also included in the screen data.

The description returns to FIG. 4.

The screen data management module 124 has a function of a notification unit that notifies the terminal device 20 of a plurality of formats of the screen data generated by the error screen data generating module 123. The screen data will be transmitted to the terminal device 20 to cause the terminal device 20 to display a screen. The screen data management module 124 may notify the terminal device 20 of the formats after the generation of the screen data, during the generation of the screen data, or before the generation of the screen data. It is assumed that the terminal device 20 is set in the MFP 10 as a transmission target when the image forming system 1 is configured with the terminal device 20 set to be used as a controller of the MFP 10.

The screen data management module 124 also has a function of receiving a specified format, out of the formats, that is transmitted from the terminal device 20 in response to the notification of the formats, and has a function of transferring the screen data in the specified format to the screen data transmission module 125 to cause the module 125 to transmit the screen data to the terminal device 20.

The screen data transmission module 125 has a function of transmitting, to the terminal device 200, the screen data transferred from the screen data management module 124. The functions of the screen data management module 124 and the screen data transmission module 125 are the function of a screen data transmission unit.

The terminal device 20 includes a UI controller 221, a job execution request module 222, a format specifying module 223, and an operational state detecting module 224.

The UI controller 221 has a function of controlling the operating module 206 and the display module 207 to receive operations from the user, and a function of displaying a screen that exhibit information to the user. The function of displaying a screen is the function of a display controlling unit. Some screens displayed on the display module 207 are generated by an application program, executed by the terminal device 20, for implementing the function of a controller of the MFP 10, and the other screens are displayed on the basis of the screen data transmitted from the screen data transmission module 125 of the MFP 10.

The job execution request module 222 has a function of requesting, when the UI controller 221 detects an instruction from a user to cause the MFP 10 to execute a job, the MFP 10 to execute the job in accordance with the instruction. The job execution module 121 of the MFP 10 receives the request and executes the job as requested.

The format specifying module 223 has a function of selecting and specifying, when notified of a plurality of formats by the screen data management module 124 of the MFP 10, a format, out of the formats, that is suitable for display on the terminal device 20, and has a function of notifying the screen data management module 124 of the specified format. The format specifying module 223 can specify the format on the basis of the size of the display included in the display module 207, the display capability such as a display control function of the UI controller 221, and the currently available processing capacity of the terminal device 20.

The display capability described above contains an element relating to display functionality such as whether the UI controller 221 has a function of processing data such as animations contained in the screen data and a function of displaying a screen based on the data. Such functionality can be determined on the basis of the operating system (OS) or application programs used by the UI controller 221 in displaying the screen. For example, when Android OS is used, such and such format can be displayed, and when the browser is used, such and such format can be displayed.

The processing capacity contains an element of processing speed such as whether the UI controller 221 can perform the processing necessary for displaying the screen within a short time so as not to make the user feel stressed. In general, processing speed is determined by static elements dependent on the performance of the hardware and by dynamically changing elements with regard to whether, for example, the terminal device 20 is currently performing any other heavy processing. The static elements may be included in the display capability described above.

The operational state detecting module 224 has a function of detecting information relating to such a dynamically changing element and has a function of providing the format specifying module 223 with the information.

Described next are operations of the MFP 10 and the terminal device 20 performed when the MFP 10 having the above functions causes the terminal device 20 to display an error notification screen for notifying the user of an error that is occurring during execution of a job.

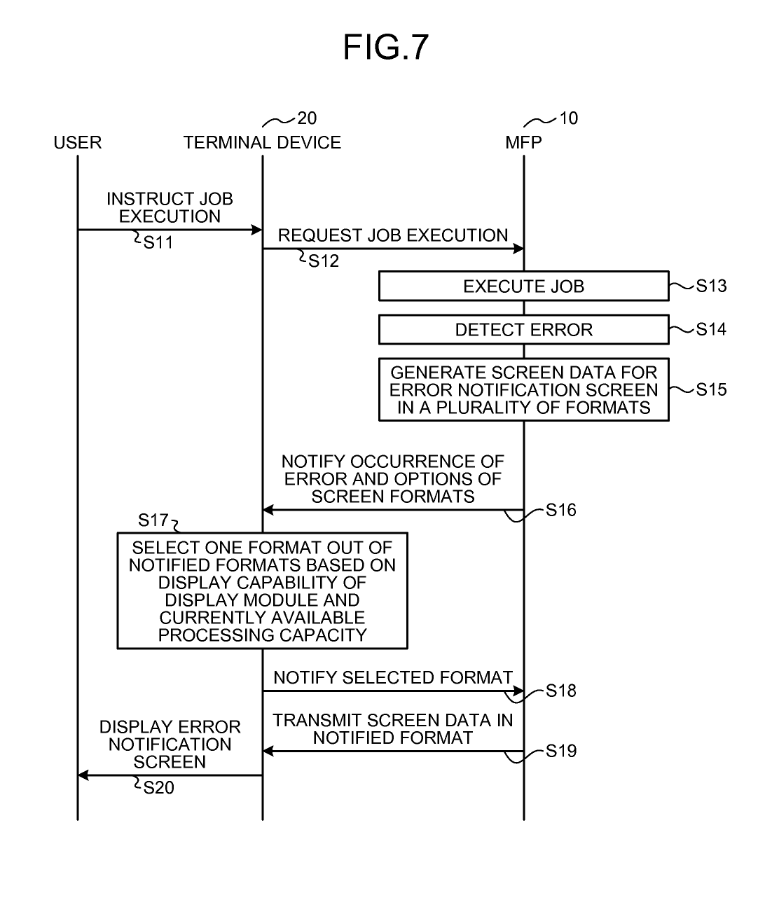

FIG. 7 is a sequence diagram illustrating the procedure of the operations.

The operations illustrated in FIG. 7 are started after the user instructs the terminal device 20 to cause the MFP 10 to execute a job. On receiving this instruction by the function of the UI controller 221 (Step S11), the terminal device 20 requests the MFP 10 to execute the job, by the function of the job execution request module 222, in accordance with the instruction (Step S12).

The MFP 10 receives the request and executes, by the function of the job execution module 121, the job as requested (Step S13). When the MFP 10 detects, by the function of the error detecting module 122, occurrence of an error during the execution of the job (Step S14), the MFP 10 generates, by the function of the error screen data generating module 123, screen data for the error notification screen that notifies the user of the terminal device 20 of the detail of the error that has occurred and its solution in the formats illustrated in FIG. 5 (Step S15). The MFP 10 then notifies, by the function of the screen data management module 124, the terminal device 20 of the occurrence of the error and options of the screen formats (formats of the screen data generated at Step S15) (Step S16). Steps S15 and S16 may be performed in the reversed order, as has been described above.

After receiving the notification at Step S16, the terminal device 20 selects, by the function of the format specifying module 223, one of the notified formats on the basis of the display capability of the display module 207 and currently available processing capacity (Step S17). The terminal device 20 notifies the MFP 10 of the selected and thus specified format (Step S18).

After receiving this notification, the MFP 10 transmits, by the functions of the screen data management module 124 and the screen data transmission module 125, screen data in the specified format, out of the screen data generated by the error screen data generating module 123, to the terminal device 20 (Step S19).

In the terminal device 20, the UI controller 221 receives the screen data, and then controls the display module 207 to display the error notification screen on the basis of the screen data (Step S20).

With the operations above, the MFP 10 can generate screen data in a plurality of formats, and the terminal device 20 can select, on the basis of the capabilities and the state of its own, a piece of screen data, out of the generated screen data, that is suitable for display on the terminal device 20, and can display the selected screen data. This configuration enables, when the same MFP 10 is used by terminal devices 20 with various display capabilities and different processing capacity, each terminal device 20 to display a screen that can transfer necessary information to the user on the basis of the screen data transmitted from the MFP 10, irrespective of the display capability and the processing capacity of the terminal device 20.

### Second Embodiment

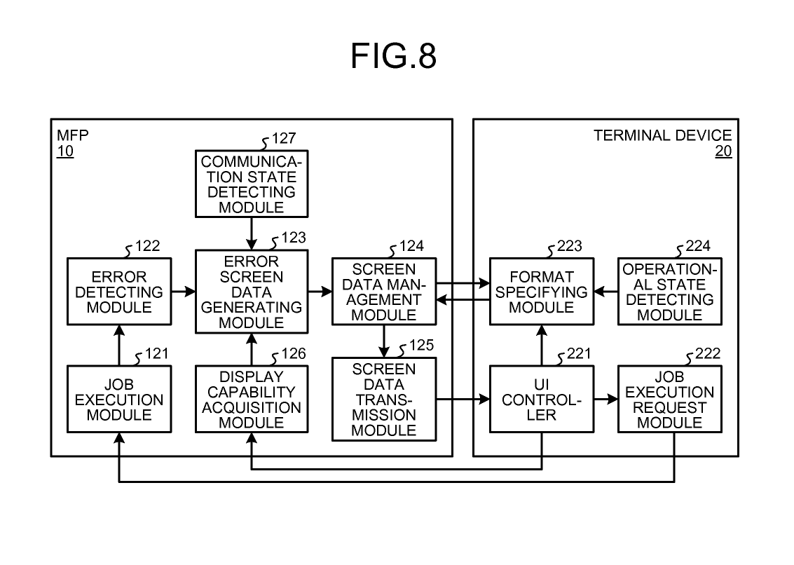

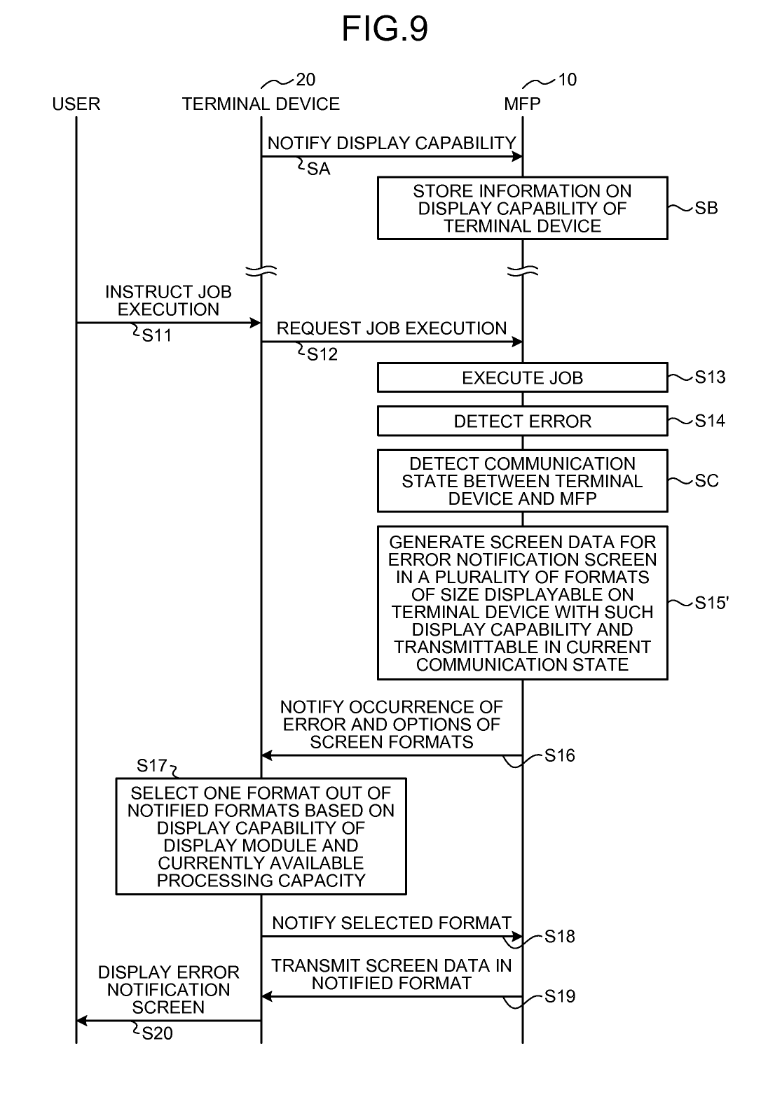

### FIGS. 8 and 9

Described next is an image forming system that is an information processing system according to a second embodiment of the present invention. The second embodiment differs from the first embodiment in that the error screen data generating module 123 narrows the format options down in consideration of the display capability of the terminal device 20 and the communication state between the MFP 10 and the terminal device 20 in generating screen data.

The other configurations in the second embodiment are the same as those in the first embodiment. Thus, the following only describes the difference described above, and the same reference signs as those in the first embodiment are given to the same or corresponding configurations in the second embodiment. The same is true for the following embodiments.

FIG. 8 is a functional block diagram, corresponding to FIG. 4, illustrating functions of the MFP 10 and the terminal device 20 according to the second embodiment.

As illustrated in FIG. 8, the MFP 10 includes a display capability acquisition module 126 and a communication state detecting module 127 in addition to the functions described in the first embodiment.

The display capability acquisition module 126 has a function of an acquisition unit that acquires information on the display capability of the terminal device 20 and provides this information for the error screen data generating module 123. As such display capability, the display capability acquisition module 126 may acquire information that will not change depending on the operational state of the terminal device 20, such as a size of the display and a type of software used by the terminal device 20 for display. The display capability acquisition module 126 may acquire the information on display capability when, for example, the terminal device 20 is connected with the MFP 10, or is set as the controller of the MFP 10. This configuration, however, does not eliminate other configurations such as acquiring the information by inquiring the terminal device 20 as necessary, or by regularly inquiring the terminal device 20. In the terminal device 20, the UI controller 221 has the function of notifying the display capability.

The communication state detecting module 127 has a function of a detecting unit that detects communication state between the terminal device 20 and the MFP 10 and provides the error screen data generating module 123 with the information on the communication state. The communication state detecting module 127 may mainly detect data transfer rate for the communication state.

The error screen data generating module 123 uses the information on the display capability provided by the display capability acquisition module 126 and the information on the communication state provided by the communication state detecting module 127 to select, from, for example, the formats illustrated in FIG. 5, all the formats or some of the formats in which screen data can be generated. The error screen data generating module 123 then generates the screen data in the selected formats. The error screen data generating module 123, for example, selects formats suitable for the screen size of the display included in the terminal device 20, prevents an animation file format that cannot be processed by the terminal device 20, or prevents formats with a large data size when the communication state is bad and the data transfer rate is late. The screen data management module 124 notifies the terminal device 20 of the selected formats as the format options.

FIG. 9 illustrates a sequence of operations, corresponding to those illustrated in FIG. 7, in the second embodiment.

As illustrated in FIG. 9, the terminal device 20 according to the second embodiment notifies in advance, by the function of the UI controller 221, the MFP 10 of the information on the display capability of the terminal device 20 (SA). In the MFP 10, the display capability acquisition module 126 receives this notification and stores therein the notified information on the display capability (SB).

Operations at and after the job execution instruction by the user at Steps S11 to S14 are the same as those illustrated in FIG. 7. The MFP 10 then detects, by the function of the communication state detecting module 127, the communication state between the MFP 10 and the terminal device 20 before generating screen data for an error notification screen (SC). The MFP 10 generates, by the function of the error screen data generating module 123, screen data for the error notification screen in formats, out of the formats illustrated in FIG. 5, that can be displayed on the terminal device having such display capability stored at Step SB, and that have data sizes with which the screen data can be transmitted under the current communication state (Step S15′).

Operations at and after Step S16 are the same as those illustrated in FIG. 7. The actual screen data may be generated in any number of formats at Step S15′. No change is required in the subsequent processing whether the screen data is generated in one format or in a plurality of formats. If the number of formats available is zero, the MFP 10 may relax the conditions for the communication state (conditions of data sizes).

With the configuration according to the second embodiment above, the MFP 10 selects, on the basis of the information acquired in advance on the display capability of the terminal device 20, formats that can be displayed on the terminal device 20 having such display capability, and generates screen data, whereby the processing loads can be reduced in generating the screen data. For example, knowing in advance that the terminal device 20 operates on Android OS, the MFP 10 only needs to generate screen data that can be displayed on Android OS.

The MFP 10 selects formats with data sizes (such as a data size that can be transferred within a certain time) in accordance with the current communication state between the MFP 10 and the terminal device 20, and generates the screen data. This configuration also reduces processing loads in generating the screen data.

### Third Embodiment

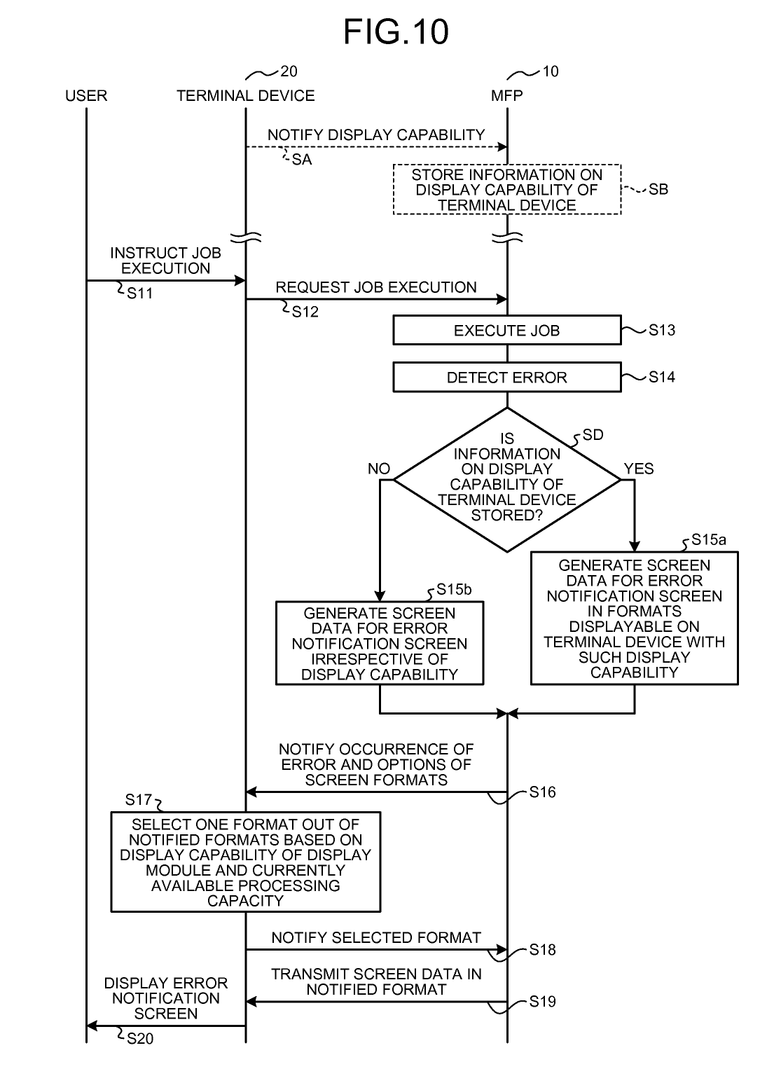

### FIG. 10

Described next is an image forming system that is an information processing system according to a third embodiment of the present invention. The third embodiment differs from the first embodiment in that the error screen data generating module 123 generates the screen data in consideration of the display capability of the terminal device 20 as in the case of the second embodiment, and also specifically prepares for a case in which the MFP 10 does not store therein any information on the display capability.

The functions of the MFP 10 and the terminal device 20 according to the third embodiment are the same as those in the second embodiment illustrated in FIG. 8, except that the configuration of the third embodiment excludes the communication state detecting module 127, which is included in the second embodiment. As described later with reference to FIG. 10, the function of the error screen data generating module 123 is slightly different from that of the second embodiment.

FIG. 10 illustrates a sequence of operations, corresponding to those illustrated in FIGS. 7 and 9, in the third embodiment.

Operations up to Step S14 illustrated in FIG. 10 are the same as those illustrated in FIG. 9. The MFP 10 then determines whether or not to store therein the information on the display capability of the terminal device 20 before generating screen data for an error notification screen (SD). In a normal operation, the MFP 10 stores therein this information at Step SB, but there may be a case in which the MFP 10 fails to acquire the information for some reasons. Alternatively, when the MFP 10 is configured to acquire the information on the display capability by requesting the terminal device 20 to transmit the information, there may be a case in which the MFP 10 fails to acquire the information because the terminal device 20 was in sleep when requested.

The MFP 10 performs different operations, by the function of the error screen data generating module 123, before generating screen data for an error notification screen depending on the result determined at Step SD. In other words, if yes at Step SD, the MFP 10 generates screen data for the error notification screen in formats, out of the formats illustrated in FIG. 5, that can be displayed on the terminal device 20 having such display capability stored at Step SB (Step S15a). If no at Step SD, the MFP 10 generates, irrespective of display capability of the terminal device 20, screen data for the error notification screen in all the formats illustrated in FIG. 5 in the same manner as in Step S15 in FIG. 7 (Step S15b).

Whichever operation is performed, the operations at and after Step S16 are the same as those illustrated FIG. 7.

With the configuration according to the third embodiment above, the MFP 10 can generate screen data in accordance with the display capability of the terminal device 20 in the same manner as in the second embodiment, and can also generate and transmit screen data without any problem when the information on the display capability cannot be acquired.

### Fourth Embodiment

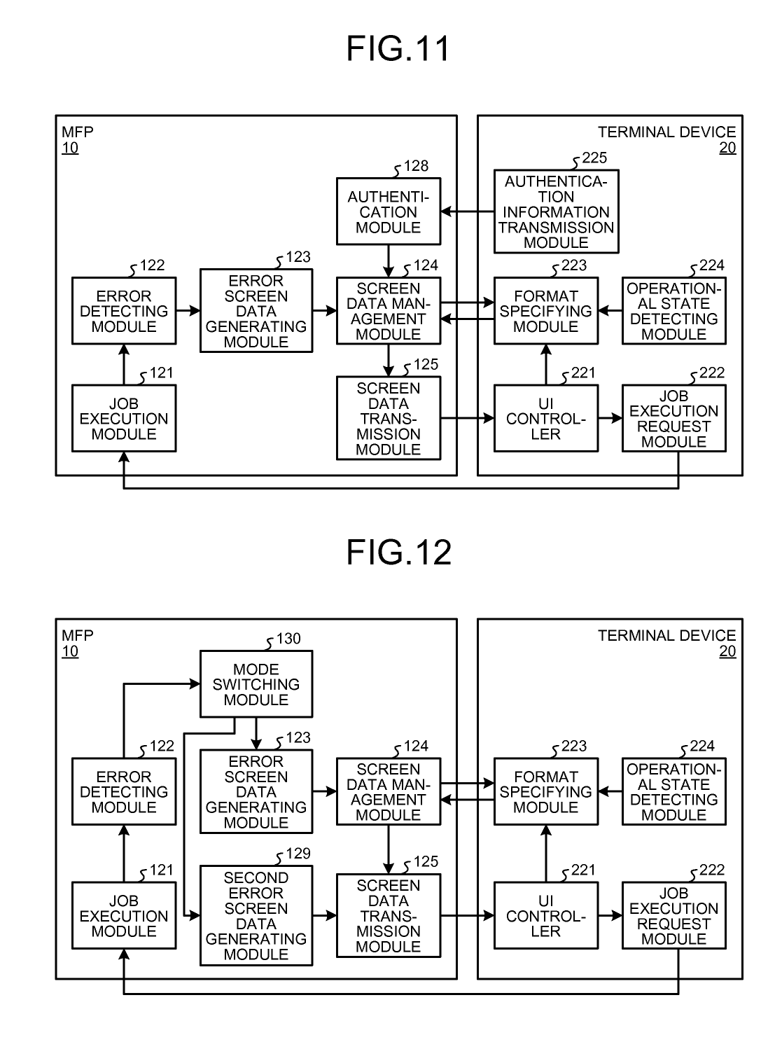

### FIG. 11

Described next is an image forming system that is an information processing system according to a fourth embodiment of the present invention. The fourth embodiment differs from the first embodiment in that the MFP 10 transmits the screen data to the terminal device 20 only when it authenticates the terminal device 20 or its user.

FIG. 11 is a functional block diagram, corresponding to FIG. 4, illustrating functions of the MFP 10 and the terminal device 20 according to the fourth embodiment.

As illustrated in FIG. 11, the MFP 10 includes an authentication module 128 in addition to the functions described in the first embodiment. The terminal device 20 includes an authentication information transmission module 225 in addition to the functions described in the first embodiment.

The authentication information transmission module 225 has a function of transmitting authentication information such as a user ID, a password, and a digital certificate to the MFP 10 to request authentication.

The authentication module 128 has a function of an authentication unit that performs authentication processing for determining, by using the transmitted authentication information, whether a transmission source has a permission to use the MFP 10.

This authentication processing may authenticate the terminal device 20 or may authenticate the user of the terminal device 20. The authentication processing may be performed when the terminal device 20 registers itself as a controller of the MFP 10, or when the terminal device 20 transmits the job execution request to the MFP 10. With this operation, the authentication processing does not need to be performed again when the screen data is transmitted.

When notified of a format by the terminal device 20 as at Step S18 in FIG. 7, the screen data management module 124 determines whether or not the authentication module 128 has successfully authenticated the transmission source, and if the transmission source has been authenticated, the MFP 10 transmits the screen data at Step S19 to the terminal device 20. If the transmission source has not been authenticated, the MFP 10 may request the terminal device 20 to transmit the authentication information and perform the authentication processing, or the MFP 10 may reject the transmission of the screen data.

With the configuration according to the fourth embodiment above, the MFP 10 can prevent screen data from being illegally acquired by a third party. In other words, if the MFP 10 transmits the screen data at Step S19 to any device irrespective of the notification source that notified a format at Step S18 in FIG. 7, the MFP 10 may transmit the screen data to a device that is different from the expected terminal device 20 upon receiving the notification from the different device. Determining whether the notification source or its user is authenticated, the MFP 10 can prevent such an event from occurring.

### Fifth Embodiment

### FIG. 12

Described next is an image forming system that is an information processing system according to a fifth embodiment of the present invention. The fifth embodiment differs from the first embodiment in that the MFP 10 is configured to be switchable between one mode in which the MFP 10 generates screen data in a plurality of formats as in the first embodiment and another mode in which the MFP 10 generates the screen data in one format alone.

FIG. 12 is a functional block diagram, corresponding to FIG. 4, illustrating functions of the MFP 10 and the terminal device 20 according to the fifth embodiment.

As illustrated in FIG. 12, the MFP 10 includes a second error screen data generating module 129 and a mode switching module 130 in addition to the functions described in the first embodiment.

The second error screen data generating module 129 has a function of generating, in one format determined in advance, screen data for an error notification screen corresponding to an error currently occurring to notify the user of the terminal device 20 of the occurrence of the error. The second error screen data generating module 129 also has a function of transferring the screen data to the screen data transmission module 125 to cause the module 125 to transmit the screen data to the terminal device 20. The functions of the second error screen data generating module 129 and the screen data transmission module 125 are the function of a second screen data transmission unit.

The format used in the second error screen data generating module 129 may be any one of the formats used in the error screen data generating module 123, or may be any other format. The user may specify which format to use in the second error screen data generating module 129.

The mode switching module 130 has a function of a switching unit that switches the error screen data generating module 123 and the second error screen data generating module 129 with respect to which module is used to generate screen data for an error notification screen corresponding to a detected error, that is, with respect to which functional unit is enabled. The mode switching module 130 may switch the modules on the basis of the setting set by the user.

When the error screen data generating module 123 generates screen data, the MFP 10 notifies the terminal device 20 of the format options and causes the terminal device 20 to select one format in the same manner as in FIG. 7. When, however, the second error screen data generating module 129 generates the screen data, the MFP 10 does not notifies the terminal device 20 of such options, but directly transmits the generated screen data to the terminal device 20 and causes the UI controller 221 to display the screen data. Switching processing performed by the mode switching module 130 includes switching of such operational modes.

With the configuration according to the fifth embodiment above, the MFP 10 can switch the function on and off of generating screen data in a plurality of formats as described in the first embodiment at the user's option. When the second error screen data generating module 129 generates screen data in one format suitable for display on the terminal device 20, which eliminates the need of generating the screen data in a plurality of formats, the MFP 10 can invalidate such function to increase display processing speed. Thus, providing such a switching function is effective.

Modifications

The explanations of the embodiments are ended. In the present invention, the specific configurations of the devices, the specific procedure, the configuration of data, the types of formats used in the devices, contents of the screen, and display timing are not limited to what are described in the above embodiments.

For example, the screen data generated by the MFP 10 is not limited to the data for the error notification screen, but may be data for a help screen or a setting screen displayed in response to a request from the user.

The formats of the screen data may include other elements than those illustrated in FIG. 5.

The device that generates screen data is not limited to an image forming device or an image processing device. The device may be any information processing device, including general-purpose computers and home appliances with built-in computers, that transmits screen data to an external display device to cause the display device to display the data.

The display device does not necessarily have a function of receiving operations from the user on a displayed screen, but may only have a function of displaying screens. In other words, the terminal device 20 in the above embodiments does not necessarily have a function of controlling the MFP 10 in accordance with the operations of the user.

The present invention is applicable, as in the cases of the above embodiments, to a case in which a plurality of information processing devices share one display device, or a case in which an information processing device transmits screen data to a plurality of display devices and causes the display devices to display a screen. In the latter case, the display devices that are transmission targets may each select a different format at Step S17 (each notify the information processing device of a different format at Step S18) in FIG. 7.

The functions of the MFP 10 or the terminal device 20 according to the above embodiments may be distributed to a plurality of devices.

A computer program according to an embodiment of the present invention implements functions (in particular, functions illustrated in FIG. 4 and the corresponding drawings thereof) of the MFP 10 or the terminal device 20 in the above described embodiments by causing a computer to control certain hardware.

Such a computer program may be stored in a built-in device such as a ROM or other non-volatile storage media (a flash memory and an electrically erasable, programmable read only memory [EEPROM], for example). The computer program may be provided by being recorded on a certain non-volatile recording medium such as a memory card, a compact disc (CD), a digital versatile disc (DVD) or a Blu-ray disc. The procedure described above can be implemented by installing the computer program recorded on such a computer-readable recording medium on a computer and causing the computer to execute the computer program.

The computer program can be executed by being downloaded from an external device connected to a network and including a computer-readable recording medium that records the computer program, or from an external device connected to a network and storing the computer program in a storage unit, and by being installed on a computer to cause the computer to execute the computer program.

The configurations of the embodiments and modifications described above may be combined in any combination if the configurations are not mutually inconsistent.

The information processing device configured as described above enables an external display device that displays a screen on the basis of a screen data dynamically generated by the information processing device to display a screen that can properly transfer necessary information when the display capability of the external display device varies.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
a screen data generating unit that generates, in a plurality of formats, screen data to be transmitted to an external device to cause the external device to display a screen;
a notification unit that notifies the external device of the formats of the screen data generated by the screen data generating unit; and
a screen data transmission unit that transmits, in accordance with specification of a format, out of the formats, that is transmitted from the external device in response to notification of the formats by the notification unit, the screen data generated by the screen data generating unit in the specified format to the external device.

2. The information processing device according to claim 1, further comprising:
an acquisition unit that acquires information on display capability of a screen included in the external device, wherein
the screen data generating unit generates the screen data in a format that is displayable with the display capability indicated by the information acquired by the acquisition unit.

3. The information processing device according to claim 2, wherein,
when the acquisition unit fails to acquire the information on the display capability, the screen data generating unit generates the screen data irrespective of the display capability of the external device.

4. The information processing device according to claim 1, further comprising:
an authentication unit that authenticates the external device or a user of the external device, wherein
the screen data transmission unit transmits, when the authentication unit authenticates the external device that transmits the specification of the format or authenticates the user of the external device, the screen data to the external device.

5. The information processing device according to claim 1, further comprising:
a detecting unit that detects communication state between the information processing device and the external device, wherein
the screen data generating unit generates the screen data in a format having a data size in accordance with the communication state detected by the detecting unit.

6. The information processing device according to claim 1, wherein
the screen data is data for a screen that notifies detail of an error that has occurred in the information processing device, and the screen contains information on a solution to the error.

7. The information processing device according to claim 1, further comprising:
a second screen data transmission unit that generates, in one format, screen data to be transmitted to the external device to cause the external device to display a screen and transmits the screen data to the external device; and
a switching unit that switches the screen data generating unit and the second screen data transmission unit with regard to which unit is enabled.

8. An information processing system comprising:
an information processing device; and
a display device that is external to the information processing device and includes a display unit, wherein the information processing device comprises
a screen data generating unit that generates, in a plurality of formats, screen data to be transmitted to the display device to cause the display device to display a screen,
a notification unit that notifies the display device of the formats of the screen data generated by the screen data generating unit, and
a screen data transmission unit that transmits,
in accordance with specification of a format, out of the formats, that is transmitted from the display device in response to notification of the formats by the notification unit, the screen data generated by the screen data generating unit in the specified format to the display device, and
the display device comprises
a specifying and notification unit that specifies, when the display device is notified by the information processing device of the formats, a format out of the notified formats based on display capability of the display unit included in the display device, and notifies the information processing device of the specified format, and
a display controlling unit that causes the display unit to display the screen based on the screen data transmitted from the information processing device.

9. A non-transitory computer-readable recording medium that contains a computer program that causes a computer to function as:
a screen data generating unit that generates, in a plurality of formats, screen data to be transmitted to an external device to cause the external device to display a screen;
a notification unit that notifies the external device of the formats of the screen data generated by the screen data generating unit; and
a screen data transmission unit that transmits, in accordance with specification of a format, out of the formats, that is transmitted from the external device in response to notification of the formats by the notification unit, the screen data generated by the screen data generating unit in the specified format to the external device.
